(19) United States
(12) Patent Application Publication
(10) Pub. No.: US 2011/0097042 A1
(43) Pub. Date: Apr. 28, 2011

(54) CABLE ASSEMBLY WITH FLOATABLE OPTICAL MODULE

(75) Inventors: Chi-Nan Liao, Tu-Cheng (TW); Hsien-Chu Lin, Tu-Cheng (TW)

(73) Assignee: HON HAI PRECISION INDUSTRY CO., LTD., Tu-Cheng (TW)

(21) Appl. No.: 12/913,798

(22) Filed: Oct. 28, 2010

(30) Foreign Application Priority Data
Oct. 28, 2009 (TW) 98136418

(51) Int. Cl. G02B 6/38

(52) U.S. Cl. 385/74; 385/75

(57) ABSTRACT

An cable assembly (100) includes an insulative housing (1) having a main portion (11) and a tongue portion (12) extending forwardly from the main portion, a cavity (121) defined in the tongue portion, and a retaining slot (112) defined in the main portion; a plurality of terminals (2) retained in the insulative housing; an optical module (3) accommodated in the cavity; an elastic member (4) sandwiched between the insulative housing and the optical module; a cable including at least one fiber (81), the fiber passing through the retaining slot and connected to the optical module; and a metallic shell (7) including a plurality of walls forming a frame to receive the insulative housing, the frame having a top wall (711) disposed proximate to the main portion of the insulative housing (1) to minimize a gap (1120) therebetween, and the gap being smaller than a diameter of the fiber.

### FIELD OF THE INVENTION

The present invention generally relates to a cable assembly, and more particularly to a cable assembly with a floatable optical module.

### DESCRIPTION OF PRIOR ART

In many of today's processing systems, such as personal computer (PC) systems, there exist universal serial bus (USB) ports for connecting various USB devices. Some of these USB devices are frequently used by PC users. For example, these USB devices may be printers, compact disk read-only-memory (CD-ROM) drivers, digital versatile disk (DVD) drivers, cameras, keyboards, joy-sticks, hard-drives, etc. Different standards of USB technology have different bandwidths. For instance, Universal Serial Bus Specification, revision 1.1 devices are capable of operating at 12 Mbits/second(Mbps). Universal Serial Bus Specification, revision 2.0 devices are capable of operating at 480 Mbps. However, as technology progresses engineers are constantly striving to increase operating speeds.

CN Pub. Pat. No. 101345358 published on Jan. 14, 2009 discloses an optical USB connector which has a fiber device added to a USB connector. Thus, the optical USB connector can transmit electrical signals and optical signals. However, the fiber device is unable to be floatable with regard to the USB connector. It is not accurately aligned with, and optically coupled to counterpart, if there are some errors in manufacturing process.

Hence, an improved cable assembly is highly desired to overcome the aforementioned problems.

### SUMMARY OF THE INVENTION

Accordingly, an object of the present invention is to provide a cable assembly with a floatable optical module.

In order to achieve the object set forth, a cable assembly in accordance with the present invention comprises an insulative housing having a main portion and a tongue portion extending forwardly from the main portion, a cavity defined in the tongue portion, and a retaining slot defined in the main portion; a plurality of terminals retained in the insulative housing; an optical module accommodated in the cavity; an elastic member sandwiched between the insulative housing and the optical module; a cable including at least one fiber, the fiber passing through the retaining slot and connected to the optical module; and a metallic shell including a plurality of walls forming a frame to receive the insulative housing, the frame having a top wall disposed proximate to the main portion of the insulative housing to minimize a gap therebetween, and the gap being smaller than a diameter of the fiber.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the cable assembly;

FIG. 2 is a partially assembled view of the cable assembly;

FIG. 3 is an exploded, perspective view of FIG. 2;

FIG. 4 is similar to FIG. 3, but viewed from another aspect;

FIG. 5 is other partially assembled view of the cable assembly;

FIG. 6 is a top side view of FIG. 5; and

FIG. 7 is a back side view of FIG. 5.

### DETAILED DESCRIPTION OF PREFERRED EMBODIMENTS

Reference will now be made in detail to the preferred embodiment of the present invention.

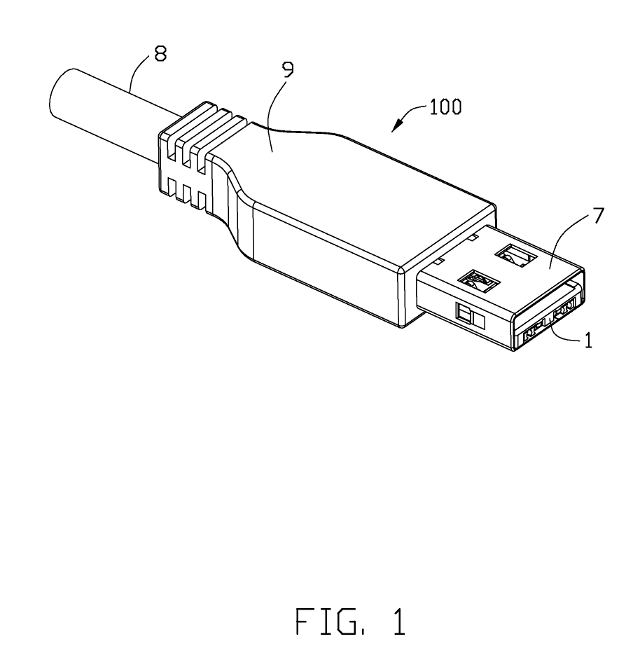

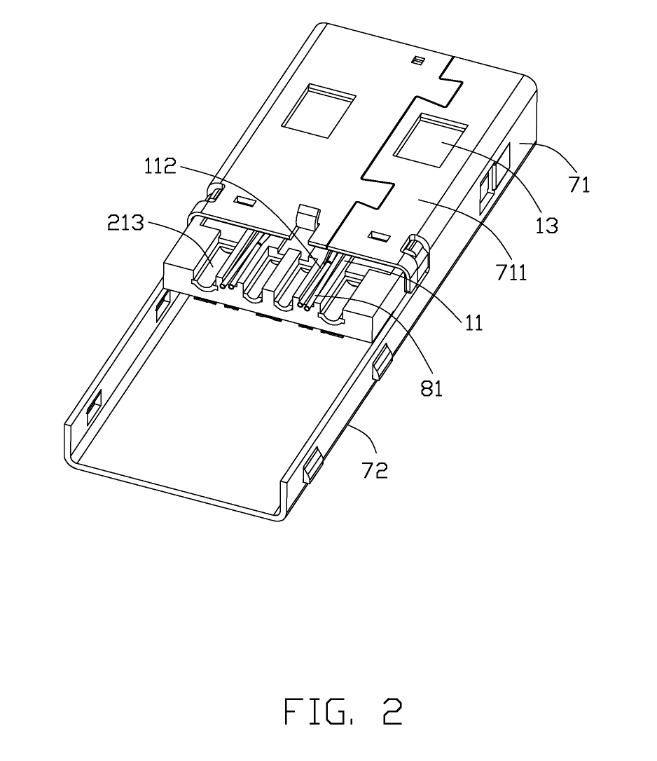

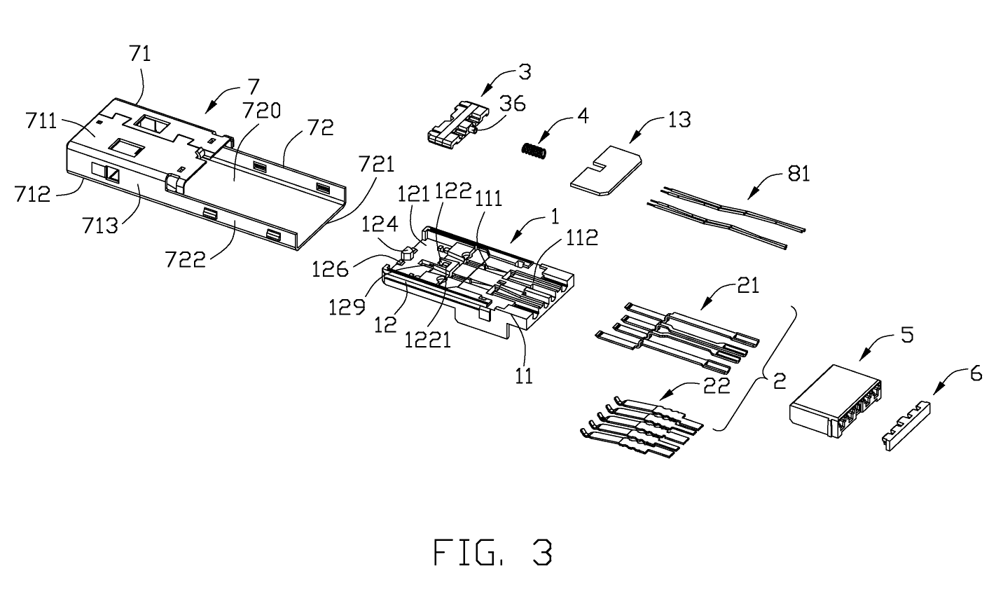

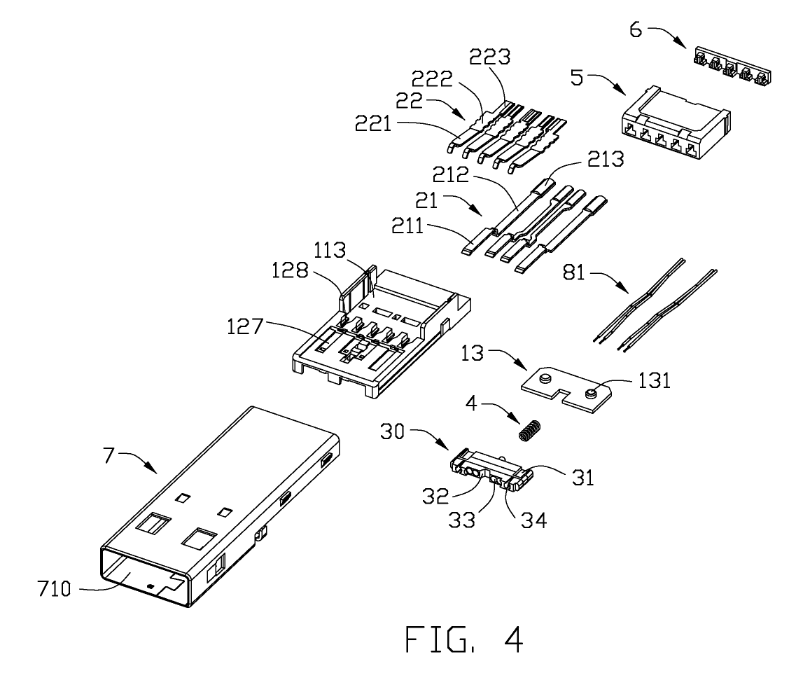

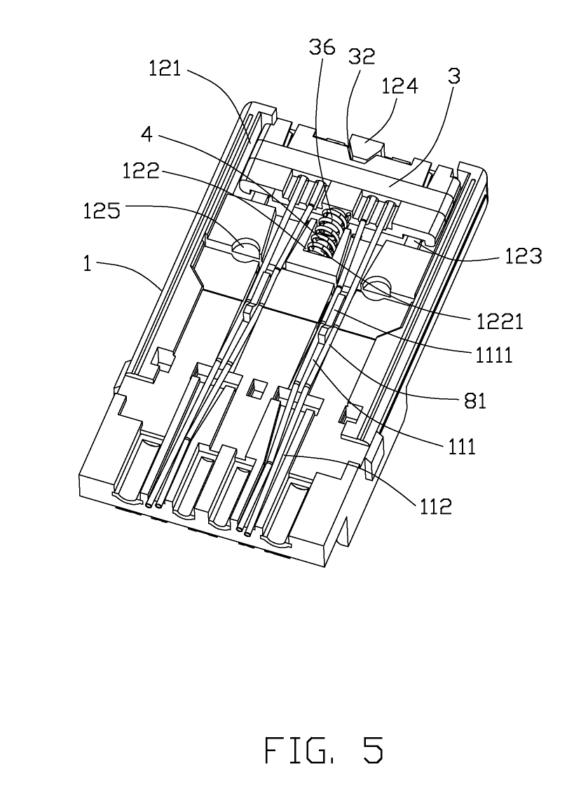

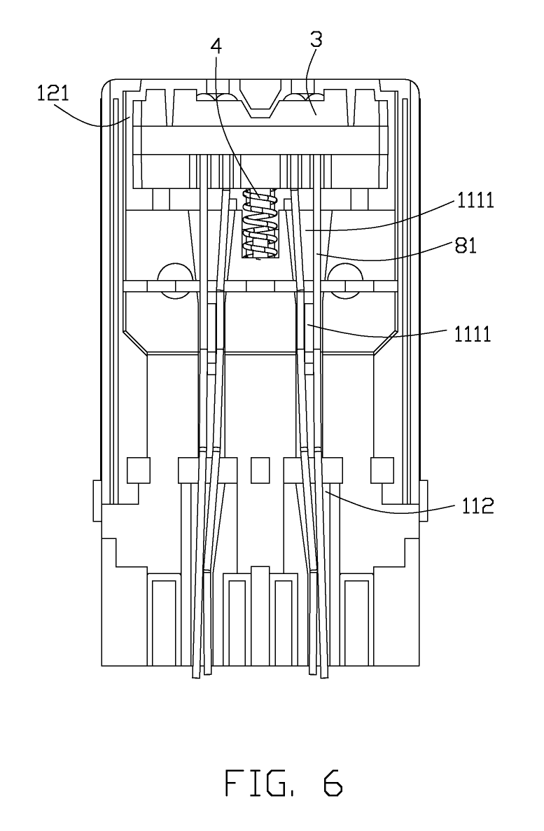

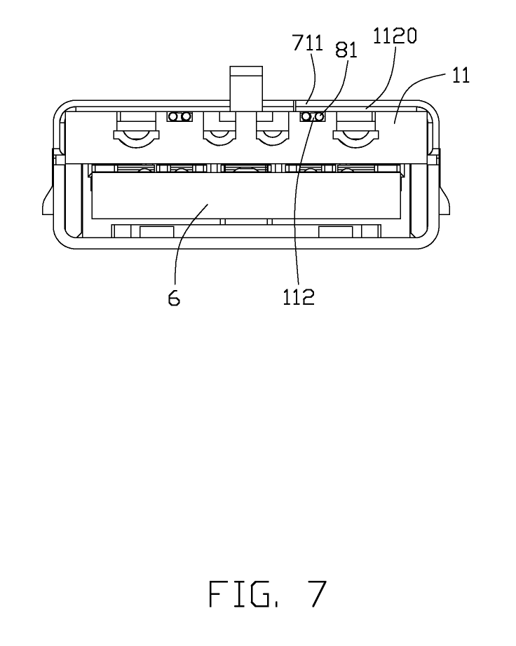

Referring to FIGS. 1-7, a cable assembly 100 in accordance with the present invention comprises an insulative housing 1, a plurality of terminals 2 retained in the insulative housing 1, an optical module 3 mounted to the insulative housing 1, an elastic member 4 sandwiched between the insulative housing 1 and the optical module 3 so as to forwardly bias the optical module 3, a terminal seat 5, a spacer 6, a metallic shell 7 shrouding the insulative housing 1, a cable 8 connecting with the terminals 2 and the optical module 3 and an external cover 9 partially enclosing the metallic shell 7 and the cable 8.

The insulative housing 1 includes a main portion 11 and a tongue portion 12 extending forwardly from the main portion 11.

There are two fiber passages 111 in a top side of a back segment of the tongue portion 12 and a front segment of the main portion 11. Each fiber passage 111 is tapered shape along front-to-back direction. A front part is wider than a back part of the fiber passage 111. There is a rib 1111 formed in a middle part of the fiber passage 111 and the rib 1111 also extends along the front-to-back direction. An upward protrusion (not labeled) is formed on a top edge of the rib 1111 for easing loading the corresponding fiber 81 into the fiber passage 111 and also for forwardly confronting the cap 13 and supporting the top wall 711 of the shell 7. There are two retaining slots 112 located in a back segment of the main portion 11. The retaining slot 112 is also configured to be tapered shape along the front-to-back segment. Furthermore, the retaining slot 112 communicates with the fiber passage 111. There is a recess 113 located in a bottom side of the main portion 11. The terminal seat 5 is accommodated in the recess 113. There is a cavity 121 defined in a top side of a front segment of the tongue portion 12. Also, there is a groove 122 defined in the tongue portion 12 and disposed behind the cavity 121. The groove 122 communicates with the cavity 121 too, and the cavity 121 further communicates with the fiber passages 111. A post 1221 is located in the groove 1221 and projects forwardly.

The elastic member 4 may be a coil spring. A rear segment of the elastic member 4 is accommodated in the groove 122, with the post 1221 inserted into the therein. Two guiding members 123 are arranged in lateral sides of the cavity 121. A notch 129 is located in the cavity 121 and disposed in front of the groove 122, so as to provide enough space for a front segment of the elastic member 4 floating along up-to-down direction. There is a V-shaped stopper 124 located in middle segment of a front end of the tongue portion 12. There are two protrusions 126 disposed at opposite sides of the stopper 124. A set of first terminal grooves 127 and a set of second terminal grooves 128 defined in a bottom side of the tongue portion. The first terminal grooves 127 are disposed in front of the second terminal grooves 128.

An arrangement of the terminals 2 is in accordance with USB 3.0 standard. The terminals 2 are divided into a set of first terminals 21 and a set of second terminals 22. The first terminals 21 and the second terminals 22 are separated into two distinct rows along the front-to-back direction.

The set of first terminals 21 have four contact members arranged in a row along the transversal direction. Each first terminal 21 substantially includes a planar retention portion 212 supported by a bottom surface of the recess 113, a mating portion 211 raised upwardly and extending forwardly from the retention portion 212 and received in the corresponding first terminal groove 127, and a tail portion 213 extending rearward from the retention portion 212. Furthermore, the mating portion 211 and the tail portion 213 are disposed at opposite sides (bottom side and top side) of the insulative housing 1.

The set of second terminals 22 have five contact members arranged in a row along the transversal direction and combined with the terminal seat 5. The set of second terminals 22 are separated into two pairs of signal terminal for transmitting differential signals and a grounding terminals disposed between the two pair of signal terminals. Each second terminal 22 includes a planar retention portion 222 received in the terminals seat 5, a curved mating portion 221 extending forward from the retention portion 222 and disposed beyond a front surface of the terminal seat 5, and a tail portion 223 extending rearward from the retention portion 222 and disposed behind a back surface of the terminal seat 5. The spacer 6 is assembled to the terminal seat 5, with a number of ribs (not numbered) thereof inserted into the grooves (not numbered) of the terminal seat 5 to position the second terminals 22.

The optical module 3 includes four lens members 33 arranged in juxtaposed manner and mounted to a base portion 30. In addition, there are two guiding grooves 31 located in lateral parts of a bottom side of the base portion 30. The base portion 30 further defines a cutout 32 in middle segment of a front side thereof. Two alignment holes 34 are respectively located in lateral segments of the front side. A mounting post 36 protrudes backwardly from a middle of a back side of the base portion 30. The optical module 3 is accommodated in the cavity 121, with the mounting post 36 inserted into a front segment of the elastic member 4. The guiding members 123 cooperate with the guiding grooves 31, when the optical module 3 moving in the cavity 121. The stopper 124 is accommodated in the cutout 32 to prevent the optical module 3 escaping from the insulative housing 1. The protrusions 126 may support the optical module 3.

The cable 8 includes four fibers 81 and a number of copper wires (not shown). The fibers 81 extend into fiber passages 111 via retaining slots 112 and are respectively coupled to the lenses 33 of the optical module 3. The copper wires are connected to the tail portions 213, 223 of the first terminals 21 and the second terminals 22. As the fiber passages 111 are configured to be tapered shape, thus there are enough space for the fibers 81 to move therein. In addition, the fibers 81 are properly inhibited within the fiber passages 111. There are two fibers 81 received in one of the fiber passages 111, and the two fibers 81 are spaced apart from each other by the rib 1111, therefore, they do not twist together. There is also a cap 13 mounted to the insulative housing 1 to shield the fiber passages 111 and the fibers 81 are positioned in the fiber passages 111. The cap 13 has two positioning members 131 formed at a bottom surface thereof and inserted into positioning holes 125 defined in the insulative housing 1. As the optical module 3 and the terminals 2 are arranged at opposite sides of the insulative housing 1, hence it facilitates manufacturing proceed.

The metallic shell 7 includes a frame 71 and a U-shaped portion 72 connected to the frame 71. The frame 71 has a top wall 711, a bottom wall 712 and a pair of side walls 713 joining with the top wall 711 and the bottom wall 712 to form a hollow 710. The U-shaped portion 72 extends backwardly from the frame 71 and has a bottom side 721 and two lateral sides 722 upwardly protruding from two lateral edges of the bottom side 721 to form a receiving space 720.

The insulative housing 1 is assembled to the metallic shell 7, with the tongue portion 12 and the front segment of the main portion 11 received in the hollow 710 of the frame 71, the back segment of the main portion 11 accommodated in the U-shaped portion 72. The top wall 711 is disposed proximate to the back segment of the main portion 11, therefore, a gap 1120 formed between the top wall 711 and the back segment of the main portion 11 is minimized. Furthermore, the gap 1120 is smaller than a diameter of the fiber 81, therefore, the fiber 81 is restrained in the retaining slots 112. There may be an inverted U-shaped portion mounted to the U-shaped portion 72.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly, comprising:
an insulative housing having a main portion and a tongue portion extending forwardly from the main portion, a cavity defined in the tongue portion, and a retaining slot defined in the main portion;
a plurality of terminals retained in the insulative housing;
an optical module accommodated in the cavity;
an elastic member sandwiched between the insulative housing and the optical module;
a cable including at least one fiber, the fiber passing through the retaining slot and connected to the optical module; and
a metallic shell including a plurality of walls forming a frame to receive the insulative housing, the frame having a top wall disposed proximate to the main portion of the insulative housing to minimize a gap therebetween, and the gap being smaller than a diameter of the fiber.

2. The cable assembly as recited in claim 1, wherein the retaining slot is tapered shape along a front-to-back direction.

3. The cable assembly as recited in claim 1, wherein there is a fiber passage defined in the insulative housing and located in front of the retaining slot.

4. The cable assembly as recited in claim 3, wherein the fiber passage communicates with the retaining slot and the cavity, and the fiber passes through the fiber passage and connects to the optical module.

5. The cable assembly as recited in claim 4, wherein there is a cap mounted to the insulative housing to shield the fiber passage.

6. The cable assembly as recited in claim 5, wherein the cap has two positioning members formed at a bottom surface thereof and inserted into positioning holes defined in the insulative housing.

7. The cable assembly as recited in claim 1, wherein the optical module includes at least one lens and a base portion, and the lens is mounted to the base portion.

8. The cable assembly as recited in claim 7, wherein the fiber is coupled to the lens.

9. The cable assembly as recited in claim 7, wherein there is a mounting post formed on a back side of the base portion of the optical module and inserted into the elastic member.

10. The cable assembly as recited in claim 9, wherein there is a groove defined in the tongue portion and disposed behind the cavity, and the elastic member extends into the groove.

11. The cable assembly as recited in claim 10, wherein there is a post formed in the groove and inserted into the elastic member.

12. The cable assembly as recited in claim 9, wherein the elastic member is a coil spring.

13. The cable assembly as recited in claim 1, wherein the terminals and the optical module are arranged at opposite sides of the insulative housing.

14. The cable assembly as recited in claim 1, wherein the terminals are divided into a set of first terminals and a set of second terminals.

15. The cable assembly as recited in claim 14, wherein the set of first terminals and the set of second terminals offset from each other along a front-to-back direction.

16. The cable assembly as recited in claim 14, wherein each of the first terminals has a mating portion and tail portion disposed at opposite sides of the insulative housing.

17. The cable assembly as recited in claim 14, wherein the set of second terminals are separated into two pairs of signal terminal for transmitting differential signals and a grounding terminals disposed between the two pair of signal terminals.

18. A cable connector assembly comprising:
an insulative housing defining an electrical transmission port and an optical transmission port at two different levels;
a plurality of electrical contacts disposed in the housing with contacting sections exposed in the electrical transmission port;
a receiving cavity defined in the housing;
an optical module received in the receiving cavity around the optical transmission port;
a resilient device constantly urging the optical module forwardly;
at least one fiber passage formed in the housing to receive a fiber of the optical module; and
a rib formed in the fiber passage to divide the passage into two parts for receiving therein two fibers in a close manner with each other; wherein
a protrusion is formed on a top edge of the rib.

19. The cable connector assembly as claimed in claim 18, wherein said protrusion contacts a metallic shell which encloses the housing.

20. A cable connector assembly comprising:
an insulative housing defining an electrical transmission port and an optical transmission port at two different levels;
a plurality of electrical contacts disposed in the housing with contacting sections exposed in the electrical transmission port;
a receiving cavity defined in the housing;
an optical module received in the receiving cavity around the optical transmission port;
a resilient device constantly urging the optical module forwardly;
at least one fiber passage formed in the housing to receive a fiber of the optical module; and
a piece covering said fiber passage in a vertical direction; wherein
a gap between the piece and the fiber passage in said vertical direction is smaller than a diameter of the fiber.
